(19) United States
(12) Patent Application Publication
(10) Pub. No.: US 2022/0300666 A1
(43) Pub. Date: Sep. 22, 2022

(54) ELECTRONIC APPARATUS AND IMAGE FORMING APPARATUS

(71) Applicant: KYOCERA Document Solutions Inc., Osaka-shi (JP)

(72) Inventor: Yasushi TSUKAMOTO, Osaka-shi (JP)

(21) Appl. No.: 17/695,059

(22) Filed: Mar. 15, 2022

(30) Foreign Application Priority Data
Mar. 17, 2021 (JP) 2021-043652

(51) Int. Cl. G06F 21/84; H04N 1/00; H04N 1/44

(52) U.S. Cl. CPC G06F 21/84; H04N 1/00392; H04N 1/00323; H04N 1/4413

(57) ABSTRACT

An electronic apparatus is provided with a display unit displaying a software keyboard and an input unit receiving user operation including key input to the software keyboard. A display control unit performs display change processing for changing at least one of the position and shape of the software keyboard and the arrangement and color scheme of each key included in the software keyboard every time the input unit receives an arbitrary number of key inputs.

### INCORPORATION BY REFERENCE

This application is based upon and claims the benefit of priority from the corresponding Japanese Patent Application No. 2021-043652 filed on Mar. 17, 2021, the entire contents of which are incorporated herein by reference.

### BACKGROUND

The present disclosure relates to an electronic apparatus and an image forming apparatus.

Disclosed is an information processing apparatus that secures the confidentiality of information displayed on a display unit such as a liquid crystal display. The information processing apparatus hides the information displayed on the display unit when there is a possibility that the information displayed on the display unit is peeked by a third party other than a user operating the information processing apparatus (so-called shoulder hacking).

### SUMMARY

An electronic apparatus includes a display unit, an input unit, and a display control unit. The display unit displays a software keyboard. The input unit receives user operation including key input to the software keyboard. The display control unit performs display change processing for changing at least one of the position and shape of the software keyboard and the arrangement and color scheme of each key included in the software keyboard every time the input unit receives an arbitrary number of key inputs.

An image forming apparatus according to the present disclosure includes the electronic apparatus. The electronic apparatus includes the display unit, the input unit, and the display control unit. The display unit displays a software keyboard. The input unit receives user operation including key input to the software keyboard. The display control unit performs display change processing for changing at least one of the position and shape of the software keyboard and the arrangement and color scheme of each key included in the software keyboard every time the input unit receives an arbitrary number of key inputs.

### BRIEF DESCRIPTION OF THE DRAWINGS

FIG. 1 is a block diagram showing a configuration example of an image forming apparatus according to the first embodiment.

FIG. 2 is a diagram showing an example of the PIN code input screen according to the first embodiment.

FIG. 3 is a diagram showing a first transition example of the PIN code input screen according to the first embodiment.

FIG. 4 is a diagram showing a second transition example of the PIN code input screen according to the first embodiment.

FIG. 5 is a diagram showing a third transition example of the PIN code input screen according to the first embodiment.

FIG. 6 is a diagram showing an example of the numeric keys included in the software keyboard in the first embodiment.

FIG. 7 is a flowchart showing an operation example of the image forming apparatus according to the first embodiment.

FIG. 8 is a block diagram showing a configuration example of the image forming apparatus according to the second embodiment.

FIG. 9 is a flowchart showing an operation example of the image forming apparatus according to the second embodiment.

### DETAILED DESCRIPTION

Hereinafter, embodiments of the present disclosure will be described with reference to the drawings. In the drawings, the same or corresponding portions are denoted by the same reference numerals and the description is not repeated.

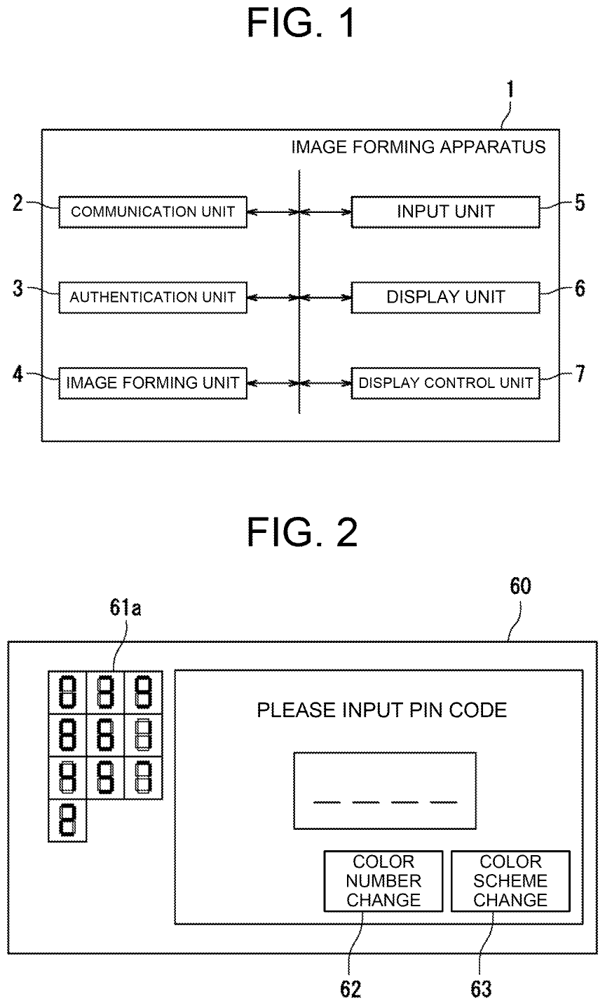

An image forming apparatus 1 according to the first embodiment will be described with reference to FIGS. 1 to 7. FIG. 1 is a block diagram showing the configuration of the image forming apparatus 1 according to the first embodiment.

The image forming apparatus 1 includes a communication unit 2, an authentication unit 3, an image forming unit 4, an input unit 5, a display unit 6, and a display control unit 7. The apparatus including the input unit 5, the display unit 6, and the display control unit 7 is an example of an electronic apparatus according to the present disclosure.

The communication unit 2 performs wireless communication or wired communication with an information terminal (not shown) owned by the user. Information terminals include smartphones, tablets, and personal computers. For example, the communication unit 2 receives image data desired by the user to form an image and a PIN code for authenticating the user from the information terminal.

The authentication unit 3 associates and stores the image data and the PIN code received by the communication unit 2 from the information terminal in association with each other. The authentication unit 3 performs user authentication using a PIN code. Specifically, when the PIN code received from the information terminal by the communication unit 2 matches the PIN code input to the input unit 5 by the user, the authentication unit 3 outputs the image data associated with the PIN code to the image forming unit 4. On the other hand, if the two PIN codes do not match, the authentication unit 3 does not output the image data to the image forming unit 4. That is, when the user inputs the correct PIN code, the user can cause the image forming apparatus 1 to form an image.

The image forming unit 4 includes a photoreceptor drum, a charger, an exposure device, a developing device, a transfer device, and the like. The image forming unit 4 forms an image on a sheet by using image data acquired from the authentication unit 3, and discharges an image formed sheet to a tray.

In addition to the image forming function of the image forming unit 4, the image forming apparatus 1 may be a composite machine having an image reading function for reading image data from an original, a facsimile transmission/reception function, an electronic mail transmission function, and the like.

The display unit 6 has a display. The display unit 6 displays the screen generated by the display control unit 7. For example, the display unit 6 displays a PIN code input screen including a software keyboard when the authentication unit 3 performs user authentication. FIG. 2 is a view showing an example of the PIN code input screen 60 in the first embodiment. In the illustrated example, the display unit 6 displays the PIN code input screen 60 including the software keyboard 61a. Details of the PIN code input screen 60 will be described later.

The input unit 5 has at least a touch panel. The input unit 5 may have a physical button or the like in addition to the touch panel. The touch panel is attached to the surface of the display included in the display unit 6. The input unit 5 receives user operation to a touch panel, a physical button, etc. For example, the input unit 5 receives a user's key input to the software keyboard 61a shown in FIG. 2.

The display control unit 7 generates a screen to be displayed on the display unit 6 and makes the display unit 6 display the screen. For example, the display control unit 7 generates a PIN code input screen 60 as shown in FIG. 2. Details of the display control unit 7 will be described later.

The authentication unit 3 and the display control unit 7 have, for example, a processor such as a CPU (Central Processing Unit) and a memory such as a ROM (Read Only Memory) and a RAM (Random Access Memory). For example, the authentication unit 3 and the display control unit 7 execute various processes specified by the computer program by executing the computer program previously stored in the memory by the processor.

In the user authentication process performed by the authentication unit 3, anyone can make the image forming apparatus 1 perform image formation as long as the PIN code is known, that is, the PIN code is correct. Therefore, there is a possibility that a third party steals the PIN code and takes away the image formed sheet from the image forming apparatus 1. A way for a third party to steal a PIN code is through so-called shoulder hacking, in which a user peeks into the user's PIN code. In recent years, the size of the display screen of the image forming apparatus 1 has been increased, so that the user's convenience and recognizability have been improved. At the same time, however, there is a greater chance of shoulder-hacking by a third party. Therefore, in the first embodiment, the image forming apparatus 1 which makes shoulder hacking by a third party difficult is realized.

Specifically, each time the input unit 5 receives an arbitrary number of key inputs, the display control unit 7 performs display change processing for changing at least one of the position and shape of the software keyboard and the arrangement and color scheme of each key included in the software keyboard. Hereinafter, an arbitrary number is fixed as “1”. That is, the display control unit 7 performs display change processing of the software keyboard every time the input unit 5 receives one key input. The arbitrary number is not limited to a fixed value, and may be a variable value that changes each time the display change processing is performed. When the arbitrary number is a variable value, for example, the display control unit 7 performs display change processing when the input unit 5 receives two key inputs, then performs display change processing when the input unit 5 receives one key input, and then performs display change processing when the input unit 5 receives three key inputs.

For example, as shown in FIG. 2, the display unit 6 displays a PIN code input screen 60 for allowing the user to input a 4-digit PIN code. The PIN code input screen 60 includes a software keyboard 61a. The software keyboard 61a includes numeric keys of “1”, “2”, “3”, “4”, “5”, “6”, “7”, “8”, “9” and “0”. When a user selects a key corresponding to a PIN code among keys included in a software keyboard 61a, the input unit 5 receives the operation as a key input. The display control unit 7 performs display change processing to change the display of the software keyboard 61a every time the input unit 5 receives one key input.

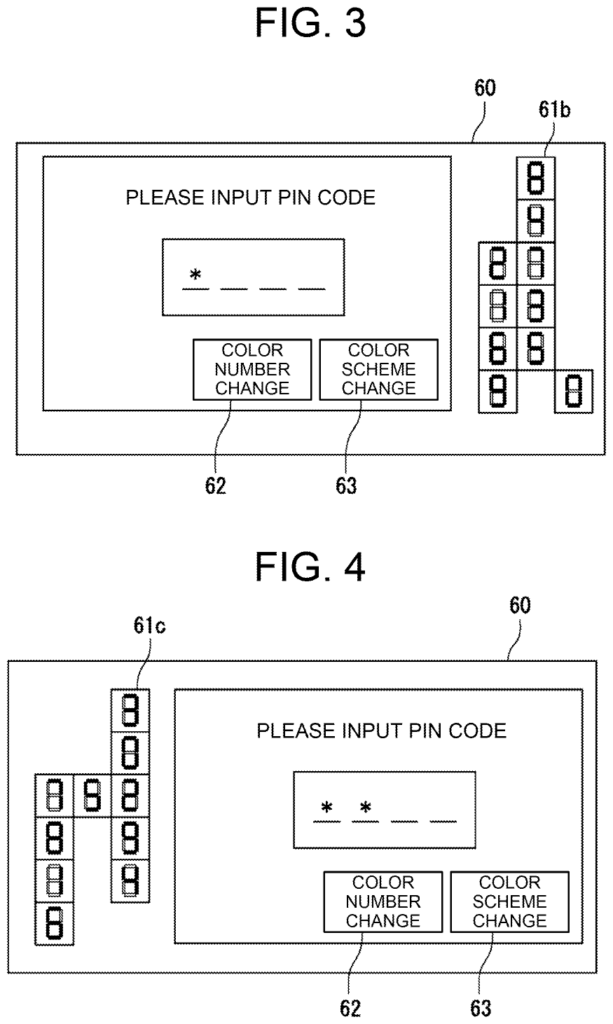

FIG. 3 is a diagram showing a first transition example of the PIN code input screen 60 in the first embodiment. When the user inputs the first character of the PIN code on the PIN code input screen 60 shown in FIG. 2, the display control unit 7 changes the software keyboard 61a shown in FIG. 2 to the software keyboard 61b shown in FIG. 3. In this example, the position and shape of the software keyboard 61a and the arrangement of the keys included in the software keyboard 61a are changed.

FIG. 4 is a diagram showing a second transition example of the PIN code input screen 60 in the first embodiment. When the user inputs the second character of the PIN code on the PIN code input screen 60 shown in FIG. 3, the display control unit 7 changes the software keyboard 61b shown in FIG. 3 to the software keyboard 61c shown in FIG. 4.

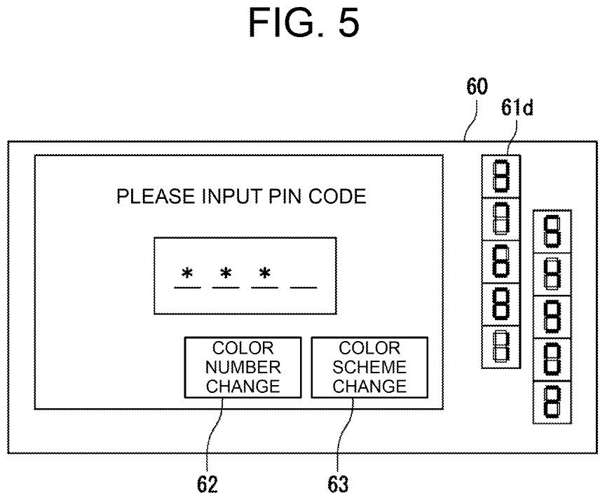

FIG. 5 is a diagram showing a third transition example of the PIN code input screen 60 in the first embodiment. When the user inputs the third character of the PIN code on the PIN code input screen 60 shown in FIG. 4, the display control unit 7 changes the software keyboard 61c shown in FIG. 4 to the software keyboard 61d shown in FIG. 5.

When the shape and key arrangement of the software keyboard are fixed, a third party can recognize a number to some extent from the position of the key even if the number of the key cannot be read. In the first embodiment, since the shape and the key arrangement of the software keyboard are changed every time a PIN code is inputted by one character, the recognizability of the key by the third party is lowered. This makes shoulder hacking by third parties difficult. The image forming apparatus 1 continues to display a PIN code input screen including a software keyboard regardless of whether there is a risk of shoulder hacking. Thus, the user can continue to enter the PIN code.

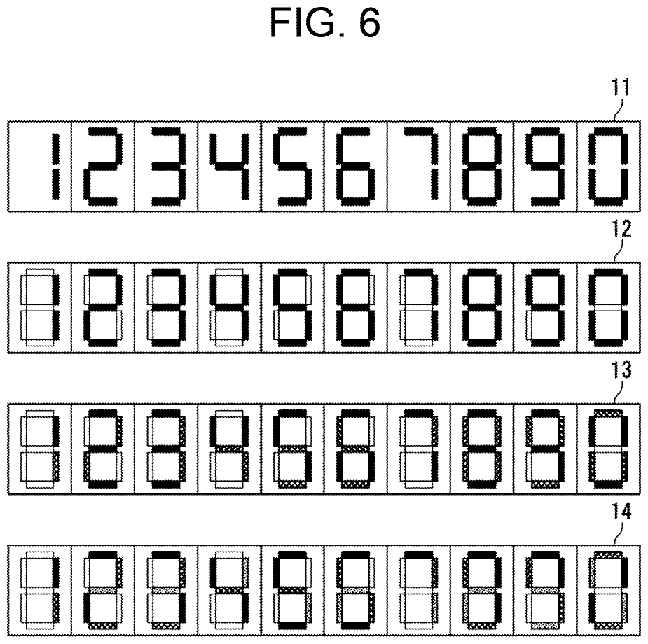

The color scheme of each key will now be described. FIG. 6 is a diagram showing an example of the numeric keys included in the software keyboard in the first embodiment. The software keyboard in the first embodiment is a segment display method. Note that the segment display method is not limited to the display method of 7 segments, and may be a display method of 9 segments, 14 segments, 16 segments, etc. Each key is not limited to a number, and may be an alphabet, a symbol, or the like.

In FIG. 6, color differences are represented by black and white and hatching. In the normal key 11, one key is composed of one color. In the two-color key 12, one key is composed of two colors. In the three-color key 13, one key is composed of three colors. In the four-color key 14, one key is composed of 4 colors. The more colors that make up a key, the less recognizable the key to the user. The display control unit 7 configures a software keyboard included in a PIN code input screen by either of 2 color keys 12, 3 color keys 13 or four-color keys 14. Alternatively, the display control unit 7 may configure the software keyboard included in the PIN code input screen by mixing the two-color keys 12, the three-color keys 13, and the four-color keys 14. In the illustrated example, one key is composed of one color, two colors, three colors, and four colors, but one key may be composed of five or more colors.

For example, when the security level of the PIN code stored in the authentication unit 3 is low, the display control unit 7 automatically increases the number of colors used for one key. Alternatively, when the security level of the PIN code stored in the authentication unit 3 is low, the display control unit 7 may generate a screen for guiding the user to perform a user operation for increasing the number of colors used for one key, and display the screen on the display unit 6. The case where the security level is low is the case where the number of digits of the PIN code is small and the case where the PIN code is a simple sequence such as “1234”, for example. For example, when the number of digits of the PIN code is smaller than a predetermined number of digits, the display control unit 7 displays a software keyboard constituted of the four-color keys 14. For example, the display control unit 7 includes a table in which a simple sequence of numbers is registered, and displays a software keyboard composed of four-color keys 14 when the PIN code matches the sequence of numbers registered in the table.

The display control unit 7 may generate a screen for guiding the user to perform a user operation for reducing the number of colors used for one key, and display the screen on the display unit 6. When the number of colors used for one key is large and it is difficult for the user to recognize the key, the user inputs a user operation for reducing the number of colors to the input unit 5. The display control unit 7 reduces the number of colors used for one key when receiving the user operation.

Further, the display control unit 7 may generate a screen for allowing the user to select whether or not to change the color combination used for one key, and display the screen on the display unit 6. When the number of colors used for one key is large and it is difficult for the user to recognize the key, the user inputs a user operation for changing the combination of colors to the input unit 5. When the user operation is received, the display control unit 7 changes the combination of colors used for one key. Changing the color combination also improves key recognizability by the user.

Alternatively, the display control unit 7 may generate a screen for allowing the user to specify a plurality of colors used for one key, and display the screen on the display unit 6. The recognizability of a key by a user improves by the user himself or herself specifying a color combination easy for the user to recognize. Further, the display control unit 7 may change both the number of colors and the combination of colors in accordance with a user operation.

For example, the display control unit 7 displays the color number change button 62 and the color scheme change button 63 such as shown in FIGS. 2 to 5 on the PIN code input screen 60. When the user operates the color number change button 62, the display control unit 7 causes the display unit 6 to display a screen (not shown) for allowing the user to specify the number of colors used for one key. When the input unit 5 receives a user operation for specifying the number of colors, the number of colors used for each key included in a software keyboard is changed to the specified number of colors. The display control unit 7 changes color combinations of respective keys included in a software keyboard when a user operates a color scheme change button 63. Note that the screen display example for changing the number of colors and changing the color scheme is not limited to the screen display example shown in FIGS. 2 to 5. The input unit 5 may have a physical button for changing the number of colors and changing the color scheme.

The display control unit 7 may change only the position of the software keyboard or only the shape of the software keyboard as a display change processing. Alternatively, the display control unit 7 may change only the key arrangement or only the key color scheme. Alternatively, the display control unit 7 may change the position and shape of the software keyboard or the position and key arrangement of the software keyboard. Alternatively, the display control unit 7 may change the position and key color scheme of the software keyboard, or may change the shape and key arrangement of the software keyboard. Alternatively, the display control unit 7 may change the shape and key color scheme of the software keyboard, or may change the arrangement and color scheme of the keys. Alternatively, the display control unit 7 may change the position, shape, and key arrangement of the software keyboard, or may change the position, key arrangement, and color scheme of the software keyboard. Alternatively, the display control unit 7 may change the position, shape, and key color scheme of the software keyboard, or may change the shape, key arrangement, and color scheme of the software keyboard. Alternatively, the display control unit 7 may change the position and shape of the software keyboard and the arrangement and color scheme of the keys. The change items from among the position and shape of the software keyboard and the arrangement and color scheme of the keys may be preset in the display control unit 7. The display control unit 7 may determine a change item according to a predetermined condition or the like. The user may specify changes.

The display control unit 7 may randomly determine the position or the like of the software keyboard each time the display change processing is performed. Alternatively, the display control unit 7 may be provided with a multitude of PIN code input screens having mutually different positions of the software keyboard or the like, and one screen may be randomly extracted from the multitude of PIN code input screens each time the display change processing is performed.

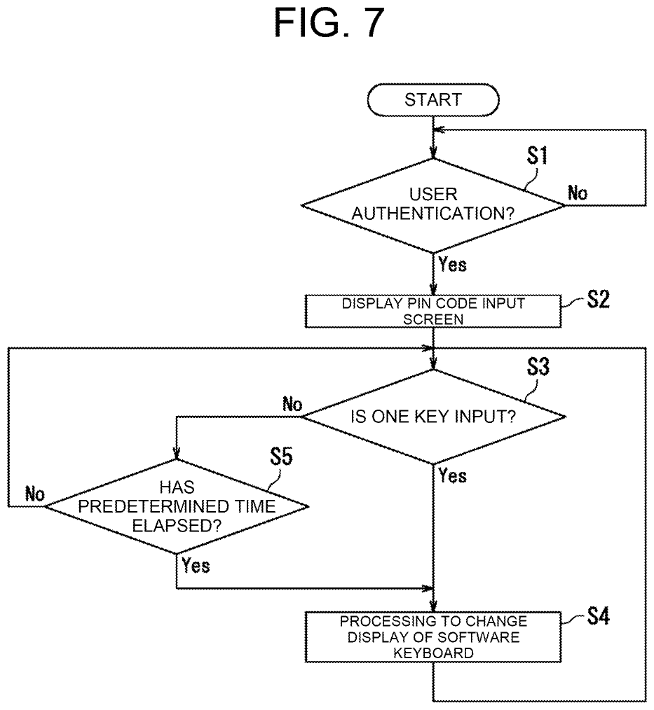

Next, the operation of the image forming apparatus 1 will be described with reference to FIG. 7. FIG. 7 is a flowchart showing an operation example of the image forming apparatus 1 according to the first embodiment. When the authentication unit 3 performs user authentication using the PIN code (step S1; Yes), the process of the display control unit 7 proceeds to step S2. Otherwise (Step S1; No), the process of the display control unit 7 returns to step S1.

In step S2, the display control unit 7 generates a PIN code input screen including a software keyboard. The display unit 6 displays the PIN code input screen generated by the display control unit 7.

In step S3, the input unit 5 receives a key input to the software keyboard and notifies the display control unit 7 of the key input each time the key input is received. When the input unit 5 receives one key input (step S3; Yes), the process of the display control unit 7 proceeds to step S4. Otherwise (Step S3; No), the process of the display control unit 7 proceeds to step S5.

In step S4, the display control unit 7 performs display change processing to change the display of the software keyboard. When the input of the PIN code is completed, the display control unit 7 terminates the operation shown in FIG. 7.

In step S5, the display control unit 7 determines whether or not a predetermined period of time has elapsed since the last time the key input was made. When a predetermined time has elapsed (step S5; Yes), the process of the display control unit 7 proceeds to step S4. If the predetermined time has not elapsed (step S5; No), the process of the display control unit 7 returns to step S3.

As described above with reference to FIGS. 1 to 7, the image forming apparatus 1 according to the first embodiment includes the display unit 6, the input unit 5, and the display control unit 7. The display unit 6 displays a software keyboard. The input unit 5 receives user operation including key input to a software keyboard. The display control unit 7 performs display change processing for changing at least one of the position and shape of the software keyboard and the arrangement and color scheme of each key included in the software keyboard every time the input unit 5 receives an arbitrary number of key inputs. Therefore, the image forming apparatus 1 can take measures against shoulder hacking by a third party without degrading the convenience of the user. The image forming apparatus 1 can notify the user of the possibility of shoulder hacking by performing display change processing.

When the input unit 5 receives a PIN code by key input to a software keyboard, the display control unit 7 changes the number of colors used for one key according to the security level of the PIN code. Thus, the image forming apparatus 1 can lower the recognizability of the key when the security level of the PIN code is low, thereby making shoulder hacking more difficult.

The input unit 5 receives an operation for specifying the number of colors used for one key by a user. The display control unit 7 changes the number of colors used for each key included in a software keyboard to a specified number of colors when the input unit 5 receives a user operation for specifying the number of colors. Thus, the image forming apparatus 1 can improve the recognizability by changing the number of colors according to the user's operation, for example, when the number of colors is increased due to the low security level of the PIN code, thereby making it difficult for the user to recognize the key.

The input unit 5 receives an operation for specifying a combination of colors used for one key by a user. The display control unit 7 changes the color combination of each key included in the software keyboard to the specified combination when the input unit 5 receives the user operation for specifying the color combination. Thus, the image forming apparatus 1 can improve the recognizability by changing the combination of colors according to the user's operation, for example, when the number of colors is increased due to the low security level of the PIN code, thereby making it difficult for the user to recognize the key.

The display control unit 7 performs display change processing when the input unit 5 does not receive the key input for a predetermined period. Thus, the image forming apparatus 1 can prevent any malicious third party from being familiar with the software keyboard and easily recognizing the key.

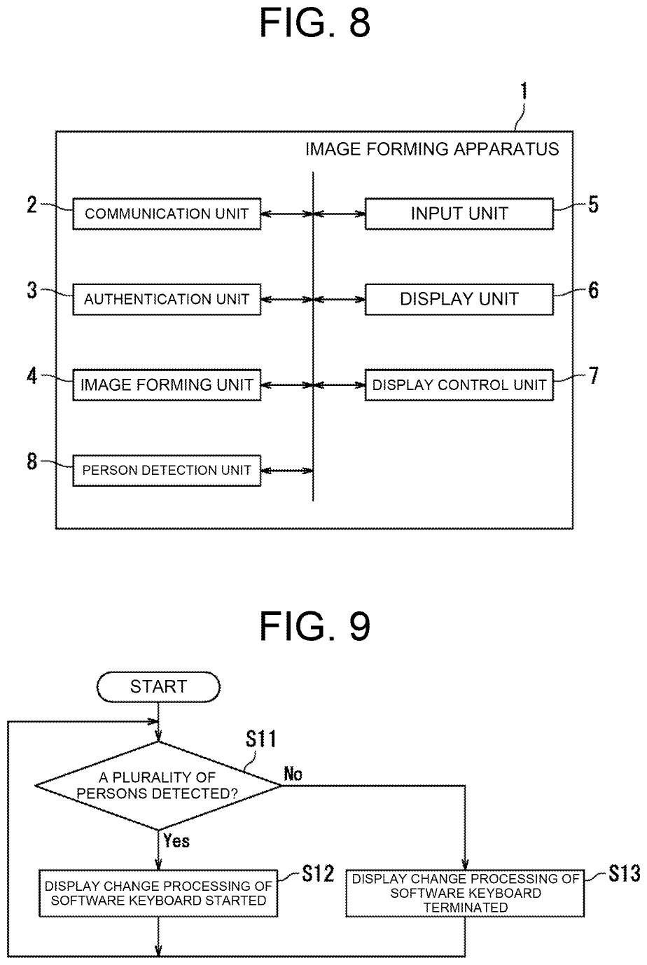

FIG. 8 is a block diagram showing a configuration example of the image forming apparatus 1 according to the second embodiment. In FIG. 8, the same reference numerals are given to the same or corresponding portions as in FIG. 1, and the description thereof is not repeated.

The image forming apparatus 1 according to the second embodiment has a configuration in which the person detection unit 8 is added to the image forming apparatus 1 according to the first embodiment shown in FIG. 1. The apparatus including the input unit 5, the display unit 6, the display control unit 7, and the person detection unit 8 is an example of the electronic apparatus according to the present disclosure.

The person detection unit 8 detects a person existing within a predetermined distance from the image forming apparatus 1. The predetermined distance is, for example, a distance capable of shoulder hacking. When a plurality of persons existing within a predetermined distance from the image forming apparatus 1 are detected, the person detection unit 8 specifies one of the detected persons as a user operating the image forming apparatus 1, and specifies the remaining persons as the third party in a shoulder hackable position. Two examples of the person detection method performed by the person detection unit 8 will be described below.

A communication unit 2 estimates a distance between the image forming apparatus 1 and each information terminal on the basis of radio wave intensity when performing radio communication with one or more information terminals existing around the image forming apparatus 1. In order to simplify the description, the information terminal closest to the image forming apparatus 1 is called “information terminal #1”, and the information terminal closest to the image forming apparatus 1 after “information terminal #1” is called “information terminal #2”. The person detection unit 8 specifies the person who owns the “information terminal #1” closest to the image forming apparatus 1 as a user who operates the image forming apparatus 1. In addition to the “information terminal #1”, the person detection unit 8 extracts the “information terminal #2” whose distance to the image forming apparatus 1 is within a predetermined distance among the information terminals whose distance is estimated by the communication unit 2. The person detection unit 8 specifies the person who owns the extracted “information terminal #2” as the third party in a distance capable of shoulder hacking.

The person detection unit 8 has a first person sensor and a second person sensor (not shown). The first person sensor is arranged at a position capable of detecting a user operating the image forming apparatus 1. The second person sensor is arranged at a position capable of detecting the third person in a position capable of shoulder hacking the display unit 6 of the image forming apparatus 1. The first person sensor and the second person sensor are sensors for detecting a person using, for example, infrared rays and ultrasonic waves. The person detection unit 8 specifies the person detected by the first person sensor as the user who operates the image forming apparatus 1. The person detection unit 8 specifies the person detected by the second person sensor as the third party in a distance capable of shoulder hacking.

The display control unit 7 performs display change processing of a software keyboard every time the input unit 5 receives an arbitrary number of key inputs during a period in which the person detection unit 8 detects a plurality of persons, that is, a period in which any third party is at a shoulder hackable distance. On the other hand, the display control unit 7 stops the display change processing of the software keyboard during a period in which only one person is detected by the person detection unit 8, that is, during a period in which there is no third party at a shoulder hackable distance.

Next, the operation of the image forming apparatus 1 will be described with reference to FIG. 9. FIG. 9 is a flowchart showing an operation example of the image forming apparatus 1 according to the second embodiment.

In step S11, the person detection unit 8 detects a person within a predetermined distance from the image forming apparatus 1. When the person detection unit 8 detects a plurality of persons (step S11; Yes), the process of the display control unit 7 proceeds to step S12. When the person detection unit 8 detects one person or less (step S11; No), the process of the display control unit 7 proceeds to step S13.

In step S12, the display control unit 7 starts the display change processing of the software keyboard. That is, the display control unit 7 performs the processes of steps S3 to S5 while the image forming apparatus 1 is executing the flowchart shown in FIG. 7.

In step S13, the display control unit 7 terminates the display change processing of the software keyboard. That is, the display control unit 7 does not perform the processes of steps S3 to S5 while the image forming apparatus 1 is executing the flowchart shown in FIG. 7.

Note that when the person detection unit 8 detects a plurality of persons (step S11; Yes), the display control unit 7 may cause the user to select whether or not to perform the display change processing of the software keyboard. For example, when the person detection unit 8 detects a plurality of persons, the display control unit 7 generates a screen for allowing the user to select whether or not display change processing is required, and displays the screen on the display unit 6. A user inputs, to the input unit 5, a user operation for performing display change processing or a user operation for stopping the display change processing. The display control unit 7 performs the processing of step S12 or step S13 according to the user operation received by the input unit 5. The input unit 5 may have a physical button for selecting the necessity of the display change processing. In this configuration, when the person detection unit 8 detects a plurality of persons, the input unit 5 enables the user operation to the physical button.

As described above with reference to FIGS. 8 and 9, the image forming apparatus 1 according to the second embodiment includes the person detection unit 8. The person detection unit 8 detects a person existing within a predetermined distance from the image forming apparatus 1. The display control unit 7 performs display change processing every time the input unit 5 receives an arbitrary number of key inputs during a period in which the person detection unit 8 detects a plurality of persons. The image forming apparatus 1 can further improve the convenience of the user by lowering the recognizability of the key when the possibility of shoulder hacking by a third party is high and not lowering the recognizability of the key when the possibility is low. In addition, the image forming apparatus 1 can notify the user of the possibility of shoulder hacking by starting the display change processing when the possibility of shoulder hacking by a third party is high.

The input unit 5 receives a user operation for instructing whether or not to perform display change processing for each of an arbitrary number of key inputs when the person detection unit 8 detects a plurality of persons. The display control unit 7 performs display change processing according to the user operation received by the input unit 5. Thus, the image forming apparatus 1 can improve user's convenience. The image forming apparatus 1 can notify the user of the possibility of shoulder hacking by displaying a screen for allowing the user to select whether or not display change processing is to be performed.

The embodiment of the present disclosure has been described with reference to the drawings (FIGS. 1 to 9). However, the present disclosure is not limited to the embodiments described above, and may be implemented in various aspects without departing from the gist thereof. Modifications 1 and 2 will be described below.

In the above embodiment, one key is composed of a plurality of colors, but is not limited to this. For example, a software keyboard is constituted of a key group constituted of a first color and a key group constituted of a second color different from the first color, and a key group constituted of the first color and a key group constituted of the second color are randomly arranged. In this way, the color of each key included in the software keyboard may be different from one another.

In the above embodiment, the display control unit 7 performs the display change processing in the case of receiving the input of the PIN code, but the case of performing the display change processing is not limited to this. The display control unit 7 can perform display change processing in a case where the input of predetermined specific information is received. The specific information is information that needs to be prevented from being leaked to a third party, such as a PIN code, an e-mail address, and a password.

What is claimed is:

1. An electronic apparatus comprising: a display unit displaying a software keyboard;
an input unit receiving a user operation including a key input to the software keyboard; and
a display control unit performing display change processing for changing at least one of (i) a position and a shape of the software keyboard and (ii) an arrangement and a color scheme of each key included in the software keyboard every time the input unit receives an arbitrary number of key inputs.

2. The electronic apparatus according to claim 1, wherein, when the input unit receives specific information predetermined by key input to the software keyboard, the display control unit changes the number of colors used for one key according to a security level of the specific information.

3. The electronic apparatus according to claim 1, wherein the input unit receives an operation in which a user specifies the number of colors used for one key, and the display control unit changes the number of colors used for each key included in the software keyboard to the specified number of colors when the input unit receives a user operation for specifying the number of colors.

4. The electronic apparatus according to claim 1, wherein the input unit receives an operation in which a user specifies a color combination used for one key, and when the input unit receives a user operation for specifying the color combination, the display control unit changes the color combination of each key included in the software keyboard to the specified color combination.

5. The electronic apparatus according to claim 1, further comprising a person detection unit detecting a person present within a predetermined distance from the electronic apparatus, wherein
the display control unit performs the display change processing every time the input unit receives an arbitrary number of key inputs during a period in which the person detection unit detects a plurality of people.

6. The electronic apparatus according to claim 5, wherein the input unit receives a user operation for instructing whether or not the display change processing is to be performed for each of an arbitrary number of key inputs when the person detection unit detects a plurality of persons;
and the display control unit performs the display change processing according to the user operation received by the input unit.

7. The electronic apparatus according to claim 1, wherein the display control unit performs the display change processing when the input unit does not receive a key input for a predetermined period.

8. An image forming apparatus comprising the electronic apparatus according to claim 1.
